(19) United States
(12) Patent Application Publication
(10) Pub. No.: US 2012/0081343 A1
(43) Pub. Date: Apr. 5, 2012

(54) Display Array of Display Panel

(75) Inventors: Biing-Der Liu, Hsin-Chu (TW); Yu-Chieh Lin, Hsin-Chu (TW); Shan-Te Chen, Hsin-Chu (TW)

(73) Assignee: AU OPTRONICS CORPORATION, Hsin-Chu (TW)

(21) Appl. No.: 13/325,381

(22) Filed: Dec. 14, 2011

Related U.S. Application Data
(62) Division of application No. 11/464,278, filed on Aug. 14, 2006.

(30) Foreign Application Priority Data
Jan. 6, 2006 (TW) 95100632

(51) Int. Cl. G06F 3/038

(52) U.S. Cl. 345/208

(57) ABSTRACT

A display array organization used in a display panel is provided. The display array includes a data line, a first scan line, a second scan line, a first pixel electrode, a second pixel electrode, a front-end switch and an intermediary switch. The first pixel electrode is connected to the data line with the front-end switch, and the second pixel electrode is connected to the first pixel electrode with the intermediary switch. The operation of the front-end switch and intermediary switch are controlled by the first and second scan line respectively. When only the front-end switch is activated, the first pixel electrode can receive the data signal from the data line. When both the front-end and intermediary switches are activated, the second pixel electrode can receive a data signal from the data line.

### RELATED APPLICATIONS

The present application is a divisional of U.S. application Ser. No. 11/464,278, filed Aug. 14, 2006, which was based on, and claims priority from, Taiwan Patent Application Serial Number 95100632, filed Jan. 6, 2006, the disclosure of which is hereby incorporated by reference herein in its entirely.

### BACKGROUND

1. Field of Invention

The present invention relates to a display array for the display panel. More particularly, the present invention relates to a data line driving multiple pixel electrodes of a display array.

2. Description of Related Art

Optoelectronics technology has undergone rapid development over the past few years, digitalization trends for many kinds of electronic devices have expanded the technical levels and the application scopes for display panels. Consequently, display panels have evolved from conventional cathode ray tube (CRT) display screens into liquid crystal display (LCD) panels and the plasma display panels. The underlying operational theory of modern display panels is very different to the operational theory of the CRT display screen and, modern display panels easily achieve the advantages of high-quality images, compact volumes, light weights, low driving voltages and low power consumption. The foregoing advantages make it suitable to apply to consumers communication and electronics products including a personal digital assistant (PDA), a cellular phone, a video cassette recorder (VCR), a personal computer (PC) or a television. Hence, LCD and plasma displays have gradually replaced the CRT display screens and have become main stream commercial products.

FIG. 1A illustrates a conventional LCD display panel using a display array 100a, which comprises a data drive circuit 102a, a scan drive circuit 104, four pixel electrodes P11, P12, P13 and P14, and four switches S11, S12, S13 and S14. Data drive circuit 102a outputs a required displaying data signal to each pixel of the pixel array. Four pixel electrodes P11, P12, P13 and P14 as illustrates in FIG. 1A are used to receive the data signal respectively in order to charge the pixel electrodes of pixel structure.

Generally, that data drive circuit 102a uses the one row per order method to output a data signal as shown in FIG. 1A, for example, using data line DL1 and DL2 to transmit a data signal for the pixel electrodes P11 and P12 respectively. However, the pixel electrode P13 and the pixel electrode P11 all obtain the data signal from the data line DL1, similarly, the pixel electrode P14 and the pixel electrode P12 all obtain the data signal from the data line DL2. Therefore it requires a switch between each pixel electrode and the data line in order to decide whether it should be activated. Hence switch S11 exists between pixel electrode P11 and data line DL1, switch S12 exists between pixel electrode P12 and data line DL2, switch S13 exists between pixel electrode P13 and data line DL1 and switch S14 exists between pixel electrode P14 and data line DL2, and the functions of the forgoing switches are controlled by the scan drive circuit 104.

Hence during normal operation shown in FIG. 1A, scan drive circuit 104 can only activate one row of switches simultaneously, for example, initially scan line GL1 simultaneously activates switch S11 and S12 to enable pixel electrodes P11 and P12 to obtain the correct data signal from the data line DL1 and DL2 respectively. Then, the scan line GL2 simultaneously activates switch S13 and S14 to enable pixel electrodes P13 and P14 to also obtain the correct data signal from the data line DL1 and DL2.

The structure of display array 100a as shown in FIG. 1A will increase the line quantity of the entire display array as a data line can only provide the requirements for one row of pixel electrodes. FIG. 1B illustrates display array 100b which has the capability to reduce the data line quantity. As shown in FIG. 1B, the data drive circuit 102b only needs a data line DL to correctly provide the data signal to the pixel electrode P11, P12, P13 and P14. This forgoing method uses switches S11, S12, S13 and S14 all connected to the data Line DL, and places the switch CS1 between the switch S12 and the data line DL, and the switch CS2 between the switch S14 and the data line DL.

Even though the scan drive circuit 104 as shown in FIG. 1B uses scan line GL1 to activate switches S11 and S12 simultaneously, the shift switch CS1 will still enable the data drive circuit 102b to initially transmit the data signal to the pixel electrode P12 and then transmit the data signal to the pixel electrode P11 with the data line DL. Similarly, when the scan drive circuit 104 uses the scan line GL2 to activate switches S13 and S14 simultaneously, the shift switch CS2 will still enable the data drive circuit 102b to initially transmit the data signal to the pixel electrode P14 and then transmit the data signal to the pixel electrode P13 with the data line DL. Operation of the shift switches CS1 and CS2 is controlled by the additional control line CON.

The structure shown in 100b can reduce the usage of data lines, but the quantity of the switches in the circuit will increase, and the usage of control signals means it will require an additional signal generating unit. These conditions will increase the complexity for the entire circuit and restrict the advantage of using this structure.

### SUMMARY

It is an objective of the present invention to provide a display array structure for the display panel.

It is another objective of the present invention to provide a display array structure in order to reduce the complexity of the entire circuit effectively.

It is still another objective of the present invention to use a data line to provide a data signal to several pixel electrodes of the display array structure.

It is still other objective of the present invention to provide a simple drive method for the display array structure.

According to the foregoing objectives of the invention, a display array structure according to an embodiment of the present invention comprises a data line, a first scan line, a second scan line, a first pixel electrode, a second pixel electrode, a front-end switch and an intermediary switch. The first pixel electrode is connected to the data line with the front-end switch, and the second pixel electrode is connected to the first pixel electrode with the intermediary switch. The operation of the front-end switch and intermediary switch are controlled by the first and second scan line respectively. When only the front-end switch is activated, the first pixel electrode receives the data signal from the data line. When both the front-end and intermediary switches are activated, the second pixel electrode receives a data signal from the data line.

According to another embodiment of a display array structure of the present invention, the display structure comprises of a data line, a plurality of scan lines and a plurality of sets of pixels arranged in series. Each set of pixels arranged in series comprises of a plurality of pixel electrodes connected in series, wherein each of the pixel electrodes is connected to another pixel electrode with an intermediary switch. One end of each set of pixels arranged in series is connected to the data line with a front-end switch. The front-end switch and each intermediary switch of each set of pixels arranged in series are controlled by the different scan lines respectively. Hence, when the intermediary switches and the front-end switches positioned between a pixel electrode and data line are activated, the pixel electrode receives a data signal from the data line.

It is to be understood that both the foregoing general description and the following detailed description are by examples, and are intended to provide further explanations of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a structure drawing of a conventional display array.

FIG. 1B is a structure drawing of another conventional display array.

FIG. 2A is a structure drawing of a display array according to one preferred embodiment of this invention.

FIG. 2B is a timing diagram according to the structure in FIG. 2A.

FIG. 2C is a position relation drawing of each pixel electrode according to the structure in FIG. 2A.

FIG. 3A is a structure drawing of a display array according to another preferred embodiment of this invention.

FIG. 3B is a position relation drawing of each pixel electrode according to the structure in FIG. 3A.

FIG. 4 is a structure drawing of a display array according to still another preferred embodiment of this invention.

FIG. 5A is a structure drawing of a display array according to still another preferred embodiment of this invention.

FIG. 5B is a timing diagram according to the structure in FIG. 5A.

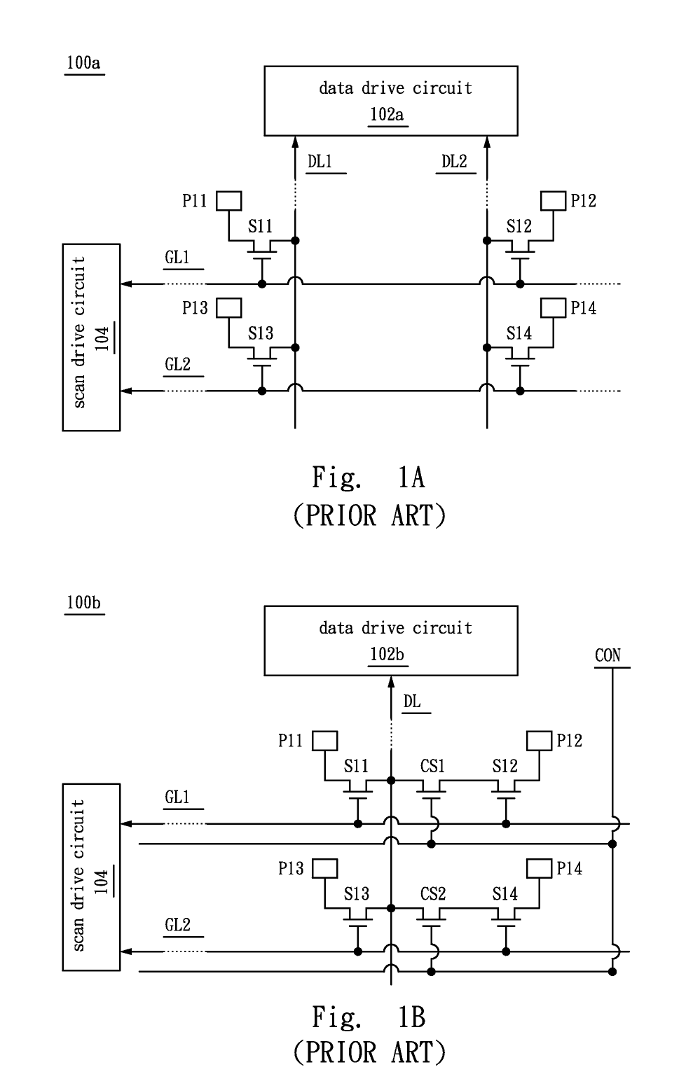

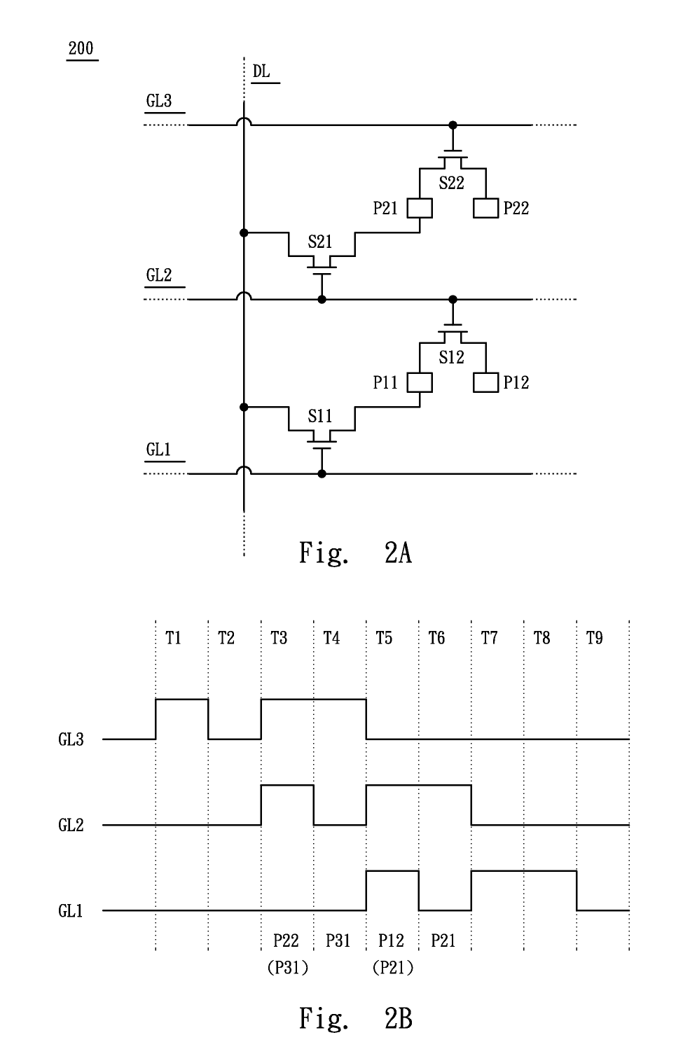

### DESCRIPTION OF THE PREFERRED EMBODIMENTS

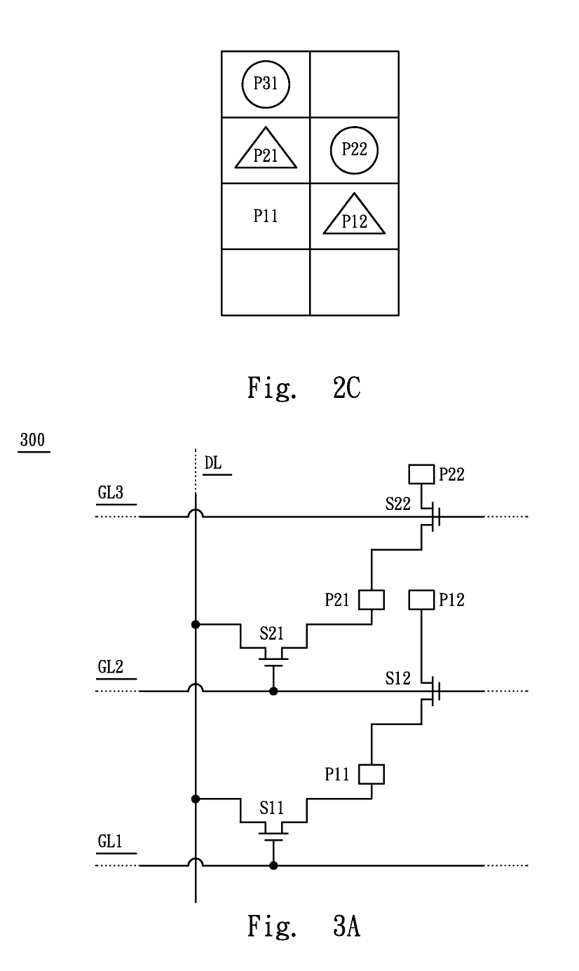

Referring to FIG. 2A, FIG. 2A illustrates the structure drawing of a display array 200 according to one preferred embodiment of this invention, wherein the structure comprises of a data line DL, a first scan line GL1, a second scan line GL2, a third scan line GL3, a first pixel electrode P11, a second pixel electrode P12, a third pixel electrode P21, a fourth pixel electrode P22, a first front-end switch S11, a second front-end switch S21, a first intermediary switch S12 and a second intermediary switch S22. The data signals required by the first pixel electrode P11, the second pixel electrode P12, the third pixel electrode P21 and the fourth pixel electrode P22 are transmitted respectively by the data line DL. The first front-end switch S11, the second front-end switch S21, the first intermediary switch S12 and the second intermediary switch S22 can be implemented with transistors. Te first pixel electrode P11 and the second pixel electrode P12 are located between the first scan line GL1 and the second scan line GL2 and located on a same side of the data line DL. The third pixel electrode P21 and the fourth pixel electrode P22 are located between the second scan line GL2 and the third scan line GL3 and located on a same side of the data line DL.

The display array 200 as illustrated in FIG. 2A, the first pixel electrode P11 connects to the data line DL through the first front-end switch S11, and the second pixel electrode P12 connects to the first pixel electrode P11 through the first intermediary switch S12. The operation of the first front-end switch S11 and the first intermediary switch S12 are controlled by the first scan line GL1 and the second scan line GL2 respectively. Similarly, the third pixel electrode P21 connects to the data line DL through the second front-end switch S21, and the fourth pixel electrode P22 connects to the third pixel electrode through the second intermediary switch S22. The operation of the second front-end switch S21 and the second intermediary switch S22 are controlled by the second scan line GL2 and the third scan line GL3 respectively.

From the structure of display array 200 shown in FIG. 2A, the first pixel electrode P11, the first intermediary switch S12 and the second pixel electrode P12 are connected in series and can be seen as a set of pixels arranged in series, and one end of the set of pixels arranged in series uses the first front-end switch S11 to connect to the data line DL; Similarly, the third pixel electrode P21, the second intermediary switch S22 and the fourth pixel electrode P22 are connected in series and can be seen as the other set of pixels arranged in series, and one end of the other set of pixels arranged in series uses the second front-end switch S21 to connect to the data line DL.

All the intermediary switches and the front-end switches of the display array 200 shown in FIG. 2A are inactivated in the normal condition, when there is a need to transmit a data signal from the data line DL to a designated pixel electrode, only the intermediary switches and the front-end switches positioned between the pixel electrode and the data line DL need to be activated. Referring to the timing diagram in FIG. 2B and the display structure in FIG. 2A, the second scan line GL2 and the third scan line GL3 activates the second front-end switch S21 and the second intermediary switch S22 respectively during the cycle T3 and subsequently the third pixel electrode P21, the fourth pixel electrode P22 and another pixel electrode P31 (not shown in FIG. 2A, positioned above the third pixel electrode P21 and uses a front-end switch controlled by the scan line GL3 connects to the data line DL) all receive data signals from Data line DL, however, the data line DL transmission provides the data signal for the fourth pixel electrode P22. The second front-end switch S21 and the second scan line GL2 are inactivated during the cycle T4 and consequently both the third pixel electrode P21 and the fourth pixel electrode P22 are not able to receive the data signal from the data line DL, and only the pixel electrode P31 receives the data signal from the data line DL. Similarly, the first pixel electrode P11, the second pixel electrode P12 and the third pixel electrode P21 are able to receive the data signal from the data line DL during the cycle T5, however, the purpose of the transmission for data line DL is to provide a data signal only for the second pixel electrode P12. The third pixel electrode P21 is only able to receive a data signal from the data line DL during the cycle T6.

Referring to FIG. 2C, FIG. 2C is a position relation drawing of each pixel electrode according to the display structure in FIG. 2A with reference to FIG. 2B, the first scan line GL1, the second scan line GL2 and the third scan line GL3 all require the same waveform model for the scan signal, which simplifies the structure for the scan drive circuit and therefore reduces the complexity for the system. However the charging order performed by the data lines using the data signal to charge the pixel electrode is not a conventional progressive charging order (the charging order is the pixel electrode P31, the fourth pixel electrode P22, the third pixel electrode P21, the second pixel electrode P12 and the first pixel electrode P11), and instead using a skip charging order (the charging order is the fourth pixel electrode P22, the pixel electrode P31, the second pixel electrode P12 and then the third pixel electrode P21).

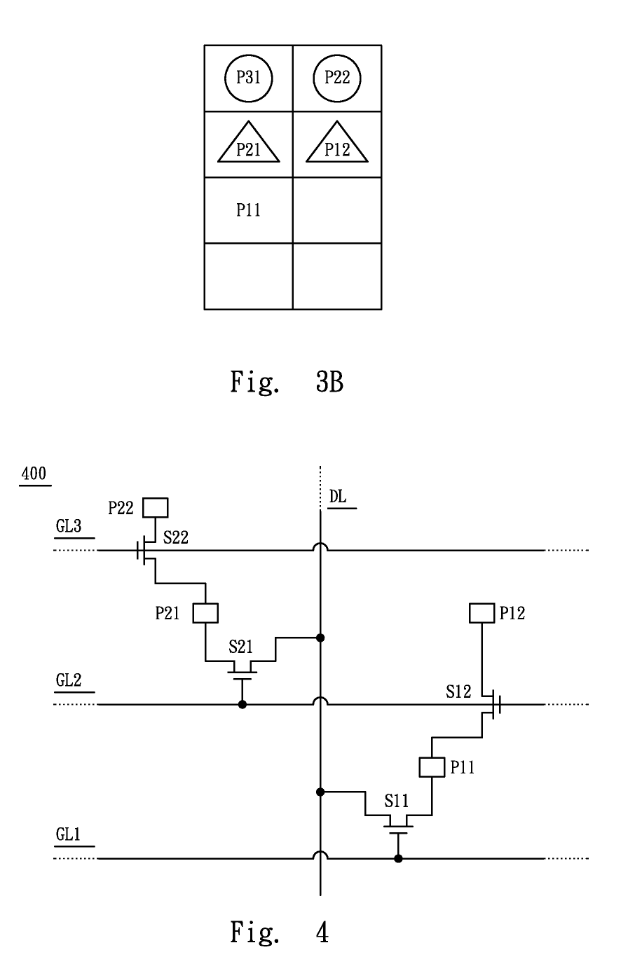

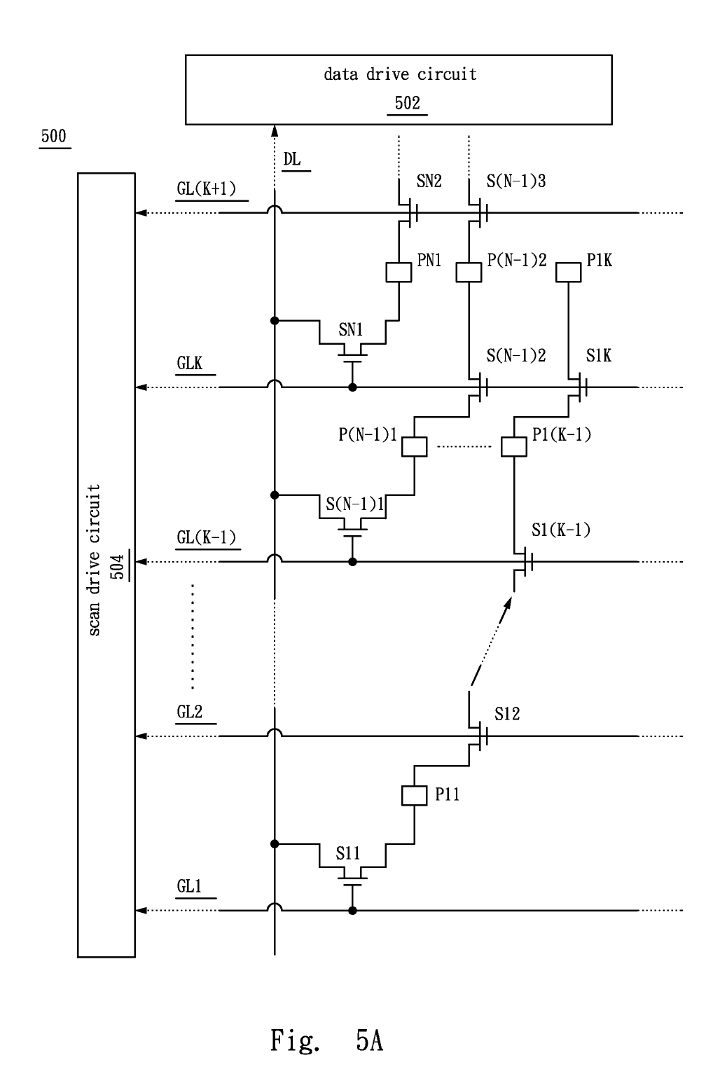

Rearranging the display order of the pixel electrodes will enable the display array of FIG. 2A to have the characteristics of a progressive charging. Referring to FIG. 3A, FIG. 3A illustrates the structure drawing of a display array 300 where the display order of the pixel electrodes in FIG. 2A are rearranged to so the display array of FIG. 2A can have progressive charging characteristics. In the display array structure 300 the second pixel electrode P12 is adjacent to the third pixel electrode P21. Hence during the cycle T5 and T6, the charging order will still be the same as for the array structure shown in FIG. 2A. The second pixel electrode P12 will be charged first and then the third pixel electrode P21 will be charged second. However, due to the rearranged position of the pixel electrodes the display array 300 will have the charging order of the pixel electrodes will have the characteristics of a progressive charging order.

Referring to FIG. 3B, FIG. 3B is a position relation drawing of each pixel electrode according to the display structure in FIG. 3A. In FIG. 3B, the position of the fourth pixel electrode P22 and the second pixel electrode P12 are moved adjacent to the pixel electrode P31 and the third pixel electrode P21 respectively. Therefore, while the original charging order is used, the characteristics of a progressive charging order can be achieved. That is, suitable positions for the pixel electrodes connect to an intermediary switch (for example, the first pixel electrode P11 and the second pixel electrode P12) to both sides of a scan line which controls the intermediary switch, and this results in simplifying the waveform on the scan line and also achieves the objective of a progressive charging order.

FIG. 2A and FIG. 3A illustrate display array 200 and display array 300 respectively, the first pixel electrode P11 and the third pixel electrode P21 are positioned on a same display row, the second pixel electrode P12 and the fourth pixel electrode P22 are positioned on a same display row. The amount of switches the data signals from data line DL must pass through to reach the first pixel electrode P11 and the third pixel electrode P21 are different from the amount of switches the data signals from the data line DL must pass through to reach the second pixel electrode P12 and the fourth pixel electrode P22 and this might results in different luminance in the display rows for the first pixel electrode P11 and the third pixel P21 and for the second pixel electrode P12 and the fourth pixel electrode P22.

Referring to FIG. 4, FIG. 4 illustrates the display structure of a display array 400 to decrease the problem of different luminance. The first set of pixels arranged in series (comprised of the first pixel electrode P11 and the second pixel electrode P12) and the second set of pixels arranged in series (comprised of the third pixel electrode P21 and the fourth pixel electrode P22) are positioned on both sides of data line DL. This enables the first pixel electrode P11 and the second pixel electrode P12 to be on the same display row, and the third pixel electrode P21 and the fourth pixel electrode P22 to be on the same display row so the average luminance of these two display rows can be determined.

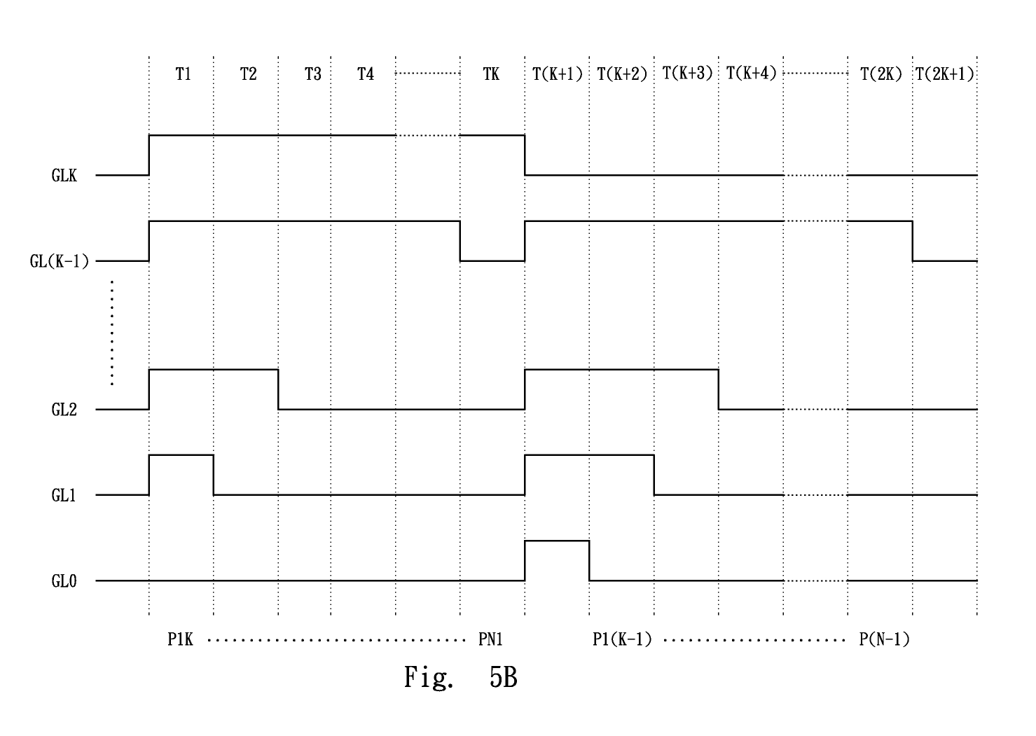

Referring to FIG. 5, FIG. 5 illustrates a display array 500 which is an extension of display array 200 of FIG. 2. Display array 500 comprises a plurality sets of pixels arranged in series (FIG. 5 illustrates N modules) connected to the data line DL, wherein each set of pixels arranged in series comprises of K pixel electrodes in series (For example, pixel electrode P11, . . . , P1(K−1) and P1K), and each pixel electrode of the set of pixels arranged in series connects to other pixel electrodes of the set of pixels arranged in series via one intermediary switch (for example, intermediary switch S1K connects pixel electrode P1(K−1) and pixel electrode P1K). One end of each set of pixels arranged in series uses a front-end switch to connect to the data line DL (for example, pixel electrode P11, . . . , P1(k−1) and P1K of the set of pixels arranged in series uses the pixel electrode P11 via the front-end switch S11 to connect to the data line DL), in addition, the operation of the front-end switch and every intermediary switch from the set of pixels arranged in series are all controlled by different scan lines (for example, the operation of the front-end switch S11 and intermediary switches S12, S1(K−1) and S1K are controlled by GL1, . . . , GK(K−1) and GLK respectively).Referring to FIG. 5A, FIG. 5A illustrates the display array 500 uses the same positioning method as for the display array 300 of FIG. 3A. Pixel electrodes (for example, pixel electrode P1(K−1) and P1K) connected by each intermediary switch (for example, intermediary switch S1K) are positioned on both sides of each respective scan line for controlling the intermediary switch (for example, scan line GLK). Hence, incorporating the timing diagram of FIG. 5B with the display array 500 of FIG. 5A can achieve the objective of a progressive charging order (for example, the charging order for pixel electrodes are P1K, . . . , P(N−1)2 and PN1 during cycle T1, . . . , T(K−1) and TK respectively, and apply same principle for charging the pixel electrodes on other display rows, for example, the progressive charging order for the pixel electrodes of one display row are P1(K−1) to P(N−1)1 during cycle T(K+1) to cycle T(2K)). Referring to FIG. 5B illustrates each scan line (for example, scan lines GL1 to GLK) use the same waveform principle and therefore can simplify the scan drive circuit for the display array 500.

For the purpose of practical use, the display array 500 of FIG. 5A can be implemented with 3 pixel electrodes with each set of pixels arranged in series, wherein each pixel electrode represents red, green and blue respectively. Hence, only one data line is needed to provide the required data signal for red, green and blue pixel electrodes of several sets of pixels arranged in series resulting in reducing the quantity of data lines needed for display array. In addition, the display array 500 can be positioned using the same positioning method illustrated in FIG. 4 of the display array 400 to equally position each set of pixels arranged in series on both sides of data line DL, and each pixel electrode from each respective set of pixels arranged in series is on the same display row to achieve the objective of average luminance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display array, for a display panel, comprising:
a first pixel electrode;
a second pixel electrode;
a third pixel electrode;
a fourth pixel electrode;
a data line capable of transmitting a data signal;
a first front-end switch, connected between the data line and the first pixel electrode;
a first intermediary switch, connected between the first pixel electrode and the second pixel electrode;
a first scan line capable of transmitting scan signals to control the first front-end switch;
a second front-end switch, connected between the data line and the third pixel electrode;
a second intermediary switch, connected between the third pixel electrode and the fourth pixel electrode;
a second scan line capable of transmitting scan signals to control the second front-end switch and the first intermediary switch, wherein the first pixel electrode and the second pixel electrode are positioned on both sides of the second scan line; and
a third scan line capable of transmitting scan signals to control the second intermediary switch, wherein the third pixel electrode and the fourth pixel electrode are positioned on both sides of the third scan line;
wherein, when the first front-end switch and the first intermediary switch are activated simultaneously, the second pixel electrode can receive the data signal, when the first front-end switch is activated, the first pixel electrode can receive the data signal, when the first front-end switch and the first intermediary switch are activated simultaneously, the second pixel electrodes can receive the data signal, when the second front-end switch is activated, the third pixel electrode can receive the data signal, when the second front-end switch and the second intermediary switch are activated simultaneously, the fourth pixel electrode can receive the data signal.

2. The display array as claimed in claim 1, wherein the first pixel electrode and the second pixel electrode are positioned on both sides of the second scan line respectively.

3. The display array as claimed in claim 1, wherein the third pixel electrode and the fourth pixel electrode are positioned on both sides of the third scan line respectively.

4. The display array as claimed in claim 1, wherein the data signal is generated by a data drive circuit of the display panel.

5. The display array as claimed in claim 1, wherein control signal transmitted by the scan line is generated by a scan drive circuit of the display panel.

6. The display array as claimed in claim 1, wherein the first front-end switch, the second front-end switch, the first intermediary switch and the second intermediary switch are transistors.

7. A method of charging each pixel electrode of the display array as claimed in claim 1, the method comprising:
activating a second front-end switch and a second intermediary switch of the display array;
inactivating the second front-end switch;
inactivating the second intermediary switch, and activating the second front-end switch, a first front-end switch and a first intermediary switch of the display array; and
inactivating the first front-end switch.

8. A display array, for a display panel, comprising:
a plurality sets of pixels arranged in series, wherein the each set of pixels arranged in series comprises of:
a plurality of pixel electrodes;
a plurality of intermediary switches, positioned respectively between the pixel electrodes in order to connect the pixel electrodes in series ;
a data line capable of transmitting a data signal for the pixel electrodes respectively;
a plurality of first front-end switches capable of connecting one end of the sets of pixels arranged in series and the data line respectively; and
a plurality of scan lines, wherein each of the scan lines transmits a scan signal to control one of the front-end switches and several intermediary switches, wherein the front-end switch and the intermediary switches controlled by each of the scan lines belong to different sets of pixels arranged in series,
wherein, the front-end switches and the intermediary switches positioned between one of the pixel electrodes and the data line are activated, the pixel electrode can receive data signal from the data line,
wherein the pixel electrodes connected by one of the intermediary switches are positioned on both sides of the scan line.

9. The display array as claimed in claim 8, wherein data signal transmitted by the data line is generated by a data drive circuit.

10. The display array as claimed in claim 8, wherein control signal transmitted by the scan lines is generated by a scan drive circuit.

11. The display array as claimed in claim 8, wherein the front-end switch and the intermediary switches are transistors.

12. The display array as claimed in claim 8, wherein among the pixel electrodes comprising pixel electrodes for displaying red, green and blue colors.

13. A display panel, comprising:
a plurality sets of pixels arranged in series, wherein each set of pixels arranged in series comprises of:
a plurality of pixel electrodes;
a plurality of intermediary switches, positioned respectively between the pixel electrodes in order to connect the pixel electrodes in series ;
a data drive circuit, uses a data line to output respective data signals for the pixel electrodes of the each set of pixels arranged in series;
a plurality of front-end switches capable of connecting one end of the sets of pixels arranged in series to the data line respectively; and
a scan drive circuit, uses the plurality of scan lines to control the front-end switches and the intermediary switches, wherein each of the scan lines transmits a scan signal to control one of the front-end switches and several intermediary switches, wherein the front-end switch and the intermediary switches controlled by each of the scan lines belong to different sets of pixels arranged in series,
wherein, the front-end switches and the intermediary switches positioned between one of the pixel electrodes of the set of pixels arranged in series and the data line are activated, the pixel electrode can receive data signal from the data line,
wherein the pixel electrodes connected by one of the intermediary switches are positioned on both sides of the scan line for controlling the intermediary switch.

14. The display panel as claimed in claim 13, wherein the set of pixels arranged in series are positioned respectively on both sides of the data line.

15. The display panel as claimed in claim 13, wherein the front-end switches and the intermediary switches are transistors.

16. The display array as claimed in claim 13, wherein among the pixel electrodes comprising pixel electrodes for displaying red, green and blue colors.
